(19) United States
(12) Patent Application Publication
(10) Pub. No.: US 2014/0164434 A1
(43) Pub. Date: Jun. 12, 2014

(54) STREAMING DATA PATTERN RECOGNITION AND PROCESSING

(71) Applicant: INTERNATIONAL BUSINESS MACHINES CORPORATION, Armonk, NY (US)

(72) Inventors: Michael J. Branson, Rochester, MN (US); John M. Santosuosso, Rochester, MN (US)

(73) Assignee: INTERNATIONAL BUSINESS MACHINES CORPORATION, Armonk, NY (US)

(21) Appl. No.: 13/709,543

(22) Filed: Dec. 10, 2012

(51) Int. Cl. G06F 17/30

(52) U.S. Cl. CPC G06F 17/30542
USPC 707/780

(57) ABSTRACT

When processing data tuples, operators of a streaming application may identify certain tuples as being relevant. To determine relevant tuples, the operators may, for example, process the received tuples and determine if they meet certain thresholds. If so, the tuples are deemed relevant, but if not they are characterized as irrelevant. The streaming application may use a pattern detector to parse the relevant data tuples to identify a pattern, such as a shared trait between the tuples. Based on this commonality, the pattern detector may generate filtering criteria that may be used to process subsequently received tuples. In one embodiment, the filtering criteria identified by one operator is transmitted to a second operator to be used to process tuples received there. Thus, once one of the operators determines a pattern, the operator generates filtering criteria that another, related operator uses for filtering received tuples.

### BACKGROUND

Embodiments of the present invention generally relate to stream applications. Specifically, the invention relates to optimizing a stream application by identifying patterns in streaming data.

While computer databases have become extremely sophisticated, the computing demands placed on database systems have also increased at a rapid pace. Database systems are typically configured to separate the process of storing data from accessing, manipulating or using data stored in the database. More specifically, databases use a model where data is first stored, then indexed, and finally queried. However, this model cannot meet the performance requirements of some real-time applications. For example, the rate at which a database system can receive and store incoming data limits how much data can be processed or otherwise evaluated. This, in turn, can limit the ability of database applications to process large amounts of data in real-time.

### SUMMARY

The present disclosure includes a system and a computer program product that receive streaming data tuples to be processed by a plurality of interconnected operators, the operators processing at least a portion of the received data tuples. The system and computer program product process tuples received by a first operator of the plurality of operators to identify relevant tuples that satisfy one or more criteria and evaluate the relevant tuples to determine a pattern based on a commonality shared by at least a portion of the relevant tuples. The system and computer program product transmit the shared commonality to a second operator of the plurality of operators and determine whether data tuples received by the second operator contain the shared commonality.

### BRIEF DESCRIPTION OF THE SEVERAL VIEWS OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIGS. 1A-1B illustrate a computing infrastructure configured to execute a stream computing application, according to embodiments described herein.

FIG. 2 is a more detailed view of the compute node of FIGS. 1A-1B, according to one embodiment described herein.

FIG. 3 is a more detailed view of the server management system of FIGS. 1A-1B, according to one embodiment described herein.

FIG. 4 is an operator graph portion where operators generate filtering criteria based on recognized patterns, according to one embodiment described herein.

FIG. 5 illustrates a method for generating filtering criteria based on recognized traits or patterns, according to one embodiment described herein.

FIG. 6 illustrates a method of using derivations of recognized traits or patterns in filtering criteria, according to one embodiment described herein.

### DETAILED DESCRIPTION

Stream-based computing and stream-based database computing are emerging as a developing technology for database systems. Products are available which allow users to create applications that process and query streaming data before it reaches a database file. With this emerging technology, users can specify processing logic to apply to inbound data records while they are “in flight,” with the results available in a very short amount of time, often in fractions of a second. Constructing an application using this type of processing has opened up a new programming paradigm that will allow for a broad variety of innovative applications, systems and processes to be developed, as well as present new challenges for application programmers and database developers.

In a stream computing application, operators are connected to one another such that data flows from one operator to the next (e.g., over a TCP/IP socket). Scalability is reached by distributing an application across nodes by creating executables (i.e., processing elements), as well as replicating processing elements on multiple nodes and load balancing among them. Operators in a stream computing application can be fused together to form a processing element that is executable. Doing so allows processing elements to share a common process space, resulting in much faster communication between operators than is available using inter-process communication techniques such as a TCP/IP socket. Further, processing elements can be inserted or removed dynamically from an operator graph representing the flow of data through the stream computing application.

When processing data (e.g., a flow of data tuples), the operators may identify certain tuples as being relevant. To determine relevant tuples, the operators may, for example, process the received tuples and determine if they meet certain thresholds. If so, the tuples are deemed relevant, but if not they are characterized as irrelevant. The streaming application may use a pattern detector to parse the relevant data tuples to identify a pattern such as a shared trait between the tuples. For example, substantially all of the relevant tuples may have the same value for an attribute in each of the tuples. Based on this commonality, the pattern detector may generate filtering criteria that may be used to process subsequently received tuples.

In one embodiment, the filtering criteria generated by evaluating the relevant tuples on one operator is transmitted to a second operator to be used to process tuples received there. For example, the two operators may perform the same algorithm when processing data but receive different data flows. Thus, once one of the operators determines a pattern, the operator generates filtering criteria that another, related operator uses for filtering received tuples—i.e., the filtering criteria is a “hint” for the other operator. In one embodiment, if the tuples received by the second operator satisfy the filtering criteria, the second operator may continue to process the tuple using code elements in the second operator. If not, the second operator may not process the tuples further.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present invention, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

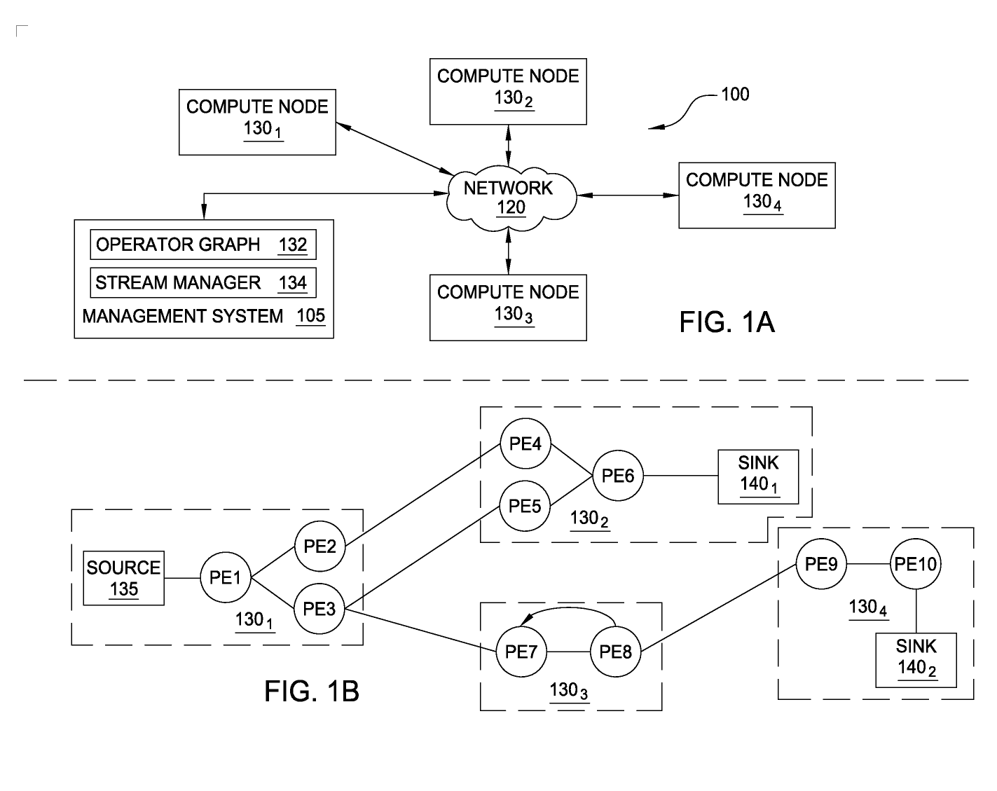

FIGS. 1A-1B illustrate a computing infrastructure configured to execute a stream computing application, according to one embodiment of the invention. As shown, the computing infrastructure 100 includes a management system 105 and a plurality of compute nodes 130₁₋₄—i.e., hosts—which are communicatively coupled to each other using one or more communication devices 120. The communication devices 120 may be a server, network, or database and may use a particular communication protocol to transfer data between the compute nodes 130₁₋₄. Although not shown, the compute nodes 130₁₋₄ may have internal communication devices for transferring data between processing elements (PEs) located on the same compute node 130.

The management system 105 includes an operator graph 132 and a stream manager 134. As described in greater detail below, the operator graph 132 represents a stream application beginning from one or more source operators through to one or more sink operators. This flow from source to sink is also generally referred to herein as an execution path. Although FIG. 1B is abstracted to show connected PEs, the operator graph 132 may comprise of execution paths where data flows between operators within the same PE or different PEs. Typically, processing elements receive an N-tuple of data attributes from the stream as well as emit an N-tuple of data attributes into the stream (except for a sink operator where the stream terminates or a source operator where the stream begins).

Of course, the N-tuple received by a processing element need not be the same N-tuple sent downstream. Additionally, PEs may be configured to receive or emit tuples in other formats (e.g., the PEs or operators could exchange data marked up as XML documents). Furthermore, each operator within a PE may be configured to carry out any form of data processing functions on the received tuple, including, for example, writing to database tables or performing other database operations such as data joins, splits, reads, etc., as well as performing other data analytic functions or operations.

The stream manager 134 may be configured to monitor a stream computing application running on the compute nodes 130₁₄, as well as to change the deployment of the operator graph 132. The stream manager 134 may move PEs from one compute node 130 to another, for example, to manage the processing loads of the compute nodes 130 in the computing infrastructure 100. Further, stream manager 134 may control the stream computing application by inserting, removing, fusing, un-fusing, or otherwise modifying the processing elements and operators (or what data tuples flow to the processing elements) running on the compute nodes 130₁₋₄. One example of a stream computing application is IBM®'s InfoSphere® Streams (note that InfoSphere® is a trademark of International Business Machines Corporation, registered in many jurisdictions worldwide).

FIG. 1B illustrates an example operator graph that includes ten processing elements (labeled as PE1—PE10) running on the compute nodes 130₁₋₄. A processing element is composed of one operator or a plurality of operators fused together into an independently running process with its own process ID (PID) and memory space. In cases where two (or more) processing elements are running independently, inter-process communication may occur using a “transport” (e.g., a network socket, a TCP/IP socket, or shared memory). However, when operators are fused together, the fused operators can use more rapid communication techniques for passing tuples among operators in each processing element relative to transmitting data between operators in different PEs.

As shown, the operator graph begins at a source 135 (that flows into the processing element labeled PE1) and ends at sink 140₁₋₂ (that flows from the processing elements labeled as PE6 and PE10). Compute node 130₁ includes the processing elements PE1, PE2 and PE3. Source 135 flows into the processing element PE1, which in turn emits tuples that are received by PE2 and PE3. For example, PE1 may split data attributes received in a tuple and pass some data attributes to PE2, while passing other data attributes to PE3. Data that flows to PE2 is processed by the operators contained in PE2, and the resulting tuples are then emitted to PE4 on compute node 130₂. Likewise, the data tuples emitted by PE4 flow to sink PE6 140₁. Similarly, data tuples flowing from PE3 to PE5 also reach sink PE6 140₁. Thus, in addition to being a sink for this example operator graph, PE6 could be configured to perform a join operation, combining tuples received from PE4 and PE5. This example operator graph also shows data tuples flowing from PE3 to PE7 on compute node 130₃, which itself shows data tuples flowing to PE8 and looping back to PE7. Data tuples emitted from PE8 flow to PE9 on compute node 130₄, which in turn emits tuples to be processed by sink PE10 140₂.

Because a processing element is a collection of fused operators, it is equally correct to describe the operator graph as execution paths between specific operators, which may include execution paths to different operators within the same processing element. FIG. 1B illustrates execution paths between processing elements for the sake of clarity.

Furthermore, although embodiments of the present invention are described within the context of a stream computing application, this is not the only context relevant to the present disclosure. Instead, such a description is without limitation and is for illustrative purposes only. Of course, one of ordinary skill in the art will recognize that embodiments of the present invention may be configured to operate with any computer system or application capable of performing the functions described herein. For example, embodiments of the invention may be configured to operate in a clustered environment with a standard database processing application.

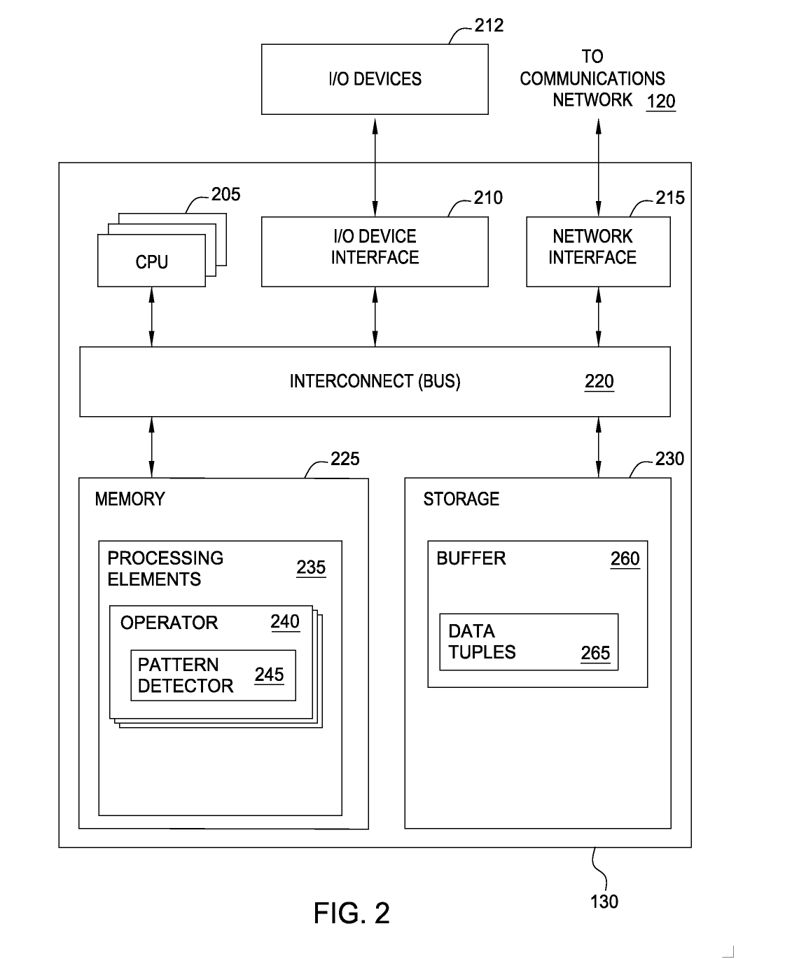

FIG. 2 is a more detailed view of the compute node 130 of FIGS. 1A-1B, according to one embodiment of the invention. As shown, the compute node 130 includes, without limitation, at least one CPU 205, a network interface 215, an interconnect 220, a memory 225, and storage 230. The compute node 130 may also include an I/O devices interface 210 used to connect I/O devices 212 (e.g., keyboard, display and mouse devices) to the compute node 130.

Each CPU 205 retrieves and executes programming instructions stored in the memory 225. Similarly, the CPU 205 stores and retrieves application data residing in the memory 225. The interconnect 220 is used to transmit programming instructions and application data between each CPU 205, I/O devices interface 210, storage 230, network interface 215, and memory 225. CPU 205 is included to be representative of a single CPU, multiple CPUs, a single CPU having multiple processing cores, and the like. In one embodiment, a PE 235 is assigned to be executed by only one CPU 205 although in other embodiments the operators 240 of a PE 235 may comprise one or more threads that are executed on a plurality of CPUs 205. The memory 225 is generally included to be representative of a random access memory (e.g., DRAM or Flash). Storage 230, such as a hard disk drive, solid state device (SSD), or flash memory storage drive, may store non-volatile data.

In this example, the memory 225 includes a plurality of processing elements 235. Each PE 235 includes a collection of operators 240 that are fused together. As noted above, each operator 240 may provide a small chunk of code configured to process data flowing into a processing element (e.g., PE 235) and to emit data to other operators 240 in the same PE or to other PEs in the stream computing application. Such processing elements may be on the same compute node 130 or on other compute nodes that are accessible via communications network 120. Each operator 240 (or select operators) may include a pattern detector 245 which identifies relevant tuples from received tuples. The pattern detector may be firmware, software, hardware, or a combination thereof that searches the data stored in the relevant tuples or the metadata associated with the tuples to identify commonalities between the tuples. For example, the operator 240 may use a particular algorithm to process the received tuples. Based on the result, the operator 240 may identify a tuple or relevant or irrelevant. From the relevant tuples, the pattern detector 245 attempt to identify a pattern or common trait between the tuples. These patterns may then be used to aid in processing the later received tuples.

As shown, storage 230 contains a buffer 260. Although shown as being in storage, the buffer 260 may located in the memory 225 of the compute node 130 or a combination of both. Moreover, storage 230 may include storage space that is external to the compute node 130.

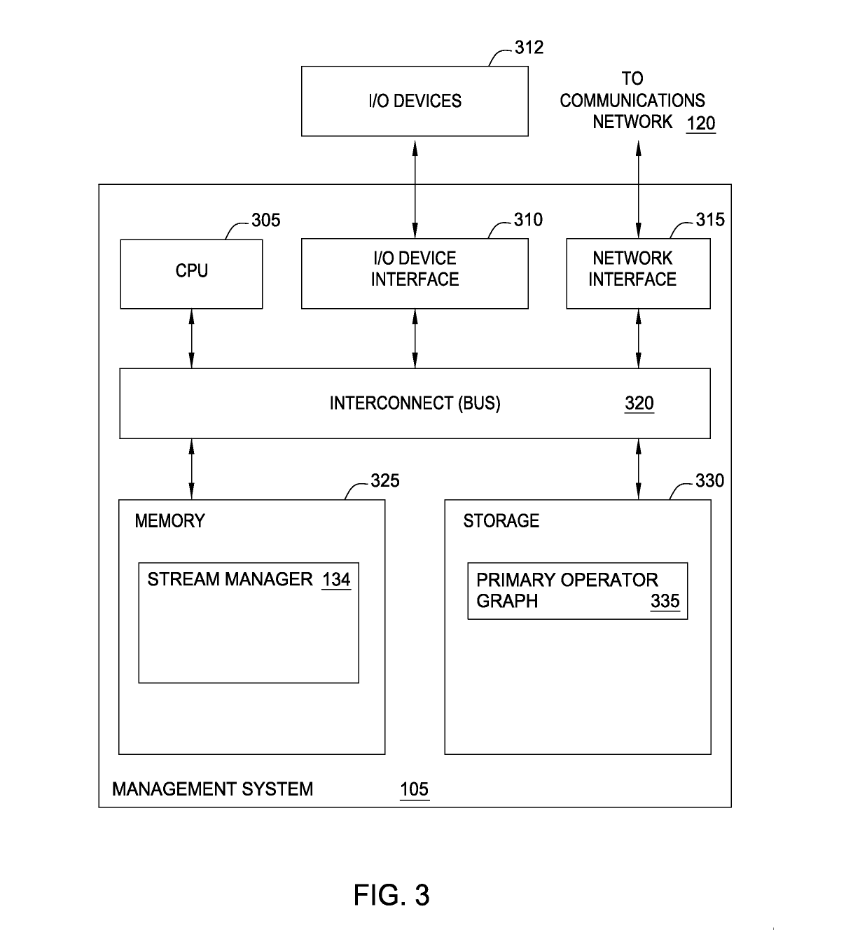

FIG. 3 is a more detailed view of the server management system 105 of FIG. 1, according to one embodiment of the invention. As shown, server management system 105 includes, without limitation, a CPU 305, a network interface 315, an interconnect 320, a memory 325, and storage 330. The client system 130 may also include an I/O device interface 310 connecting I/O devices 312 (e.g., keyboard, display and mouse devices) to the server management system 105.

Like CPU 205 of FIG. 2, CPU 305 is configured to retrieve and execute programming instructions stored in the memory 325 and storage 330. Similarly, the CPU 305 is configured to store and retrieve application data residing in the memory 325 and storage 330. The interconnect 320 is configured to move data, such as programming instructions and application data, between the CPU 305, I/O devices interface 310, storage unit 330, network interface 305, and memory 325. Like CPU 205, CPU 305 is included to be representative of a single CPU, multiple CPUs, a single CPU having multiple processing cores, and the like. Memory 325 is generally included to be representative of a random access memory. The network interface 315 is configured to transmit data via the communications network 120. Although shown as a single unit, the storage 330 may be a combination of fixed and/or removable storage devices, such as fixed disc drives, removable memory cards, optical storage, SSD or flash memory devices, network attached storage (NAS), or connections to storage area-network (SAN) devices.

As shown, the memory 325 stores a stream manager 134. Additionally, the storage 330 includes a primary operator graph 132. The stream manager 134 may use the primary operator graph 132 to route tuples to PEs 235 for processing.

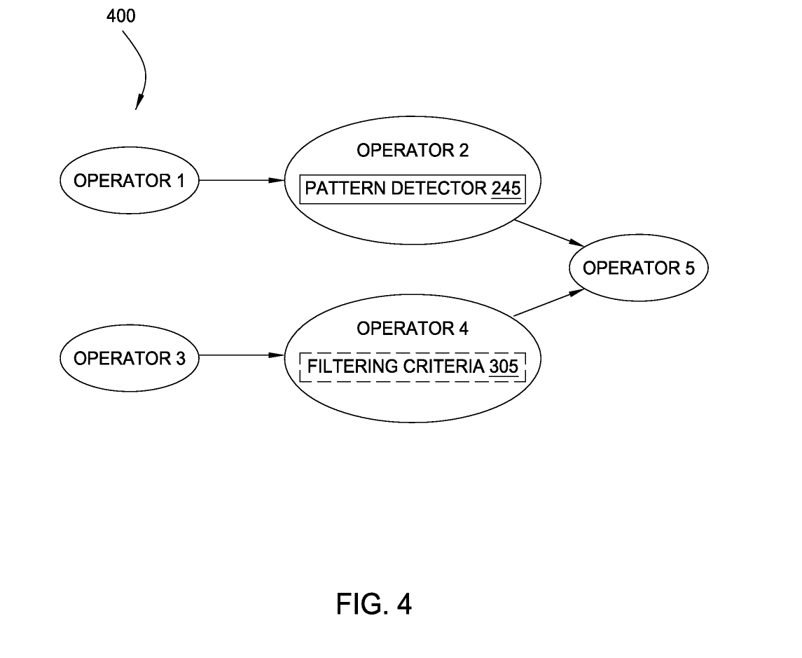

FIG. 4 is an operator graph portion 400 where operators generate filtering criteria based on recognized patterns, according to one embodiment described herein. The operator graph 400 includes operator 1-5 that may be located on one or more different processing elements. In addition, the operators 1-5 may be hosted on a single compute node or on multiple nodes. The arrows illustrate data flows between the operators. For example, operator 2 receives data tuples from operator 1, processes the tuples, and then forwards tuples to operator 5. As mentioned above, each operator may be configured to carry out any form of data processing functions on received tuples, including, for example, writing to database tables or performing other database operations such as data joins, splits, reads, etc., as well as performing other data analytic functions or operations.

Moreover, the operators may change the values stored in the tuples before passing the tuples to a downstream operator. In one embodiment, the tuples include one or more attribute value pairs—e.g., Vehicle=Car and Vehicle Color=Red—which may be altered by the operators. Before forwarding the tuple, the operator could add attribute value pairs, remove attribute pairs, or change the value associate with an attribute. In some embodiments, the operators may discard or drop the tuple rather than forward the tuple to a downstream operator—i.e., the number of incoming and outgoing tuples does not need to be equal. For example, the operator may drop tuples based on performance constraints or if the values of the tuples do not satisfy some criteria.

As shown, operator 1 forwards tuples to operator 2 which processes the received tuples and transmits one or more resulting tuples to operator 5. Similarly, operator 3 forwards tuples to operator 4 which processes the tuples and forwards the resulting tuples to operator 5. Assume that operators 2 and 4 contain code elements that define different algorithms that determine whether cars traveling down a highway will damage the road's surface. Each received tuple may have a plurality of attribute value pairs that describe a particular vehicle traveling on the highway. For example, the tuples transmitted to operator 2 and 4 may have been generated by upstream operators based on pictures taken of the dump trucks by traffic cameras. Operators 2 and 4 may use the unique algorithms to determine the damage the vehicle inflicts on the highway based on the values stored in the tuples. The algorithms may identify vehicles that cause damage above a certain threshold as relevant tuples. In one embodiment, received tuples that the algorithms indicate do not damage the road above the threshold—i.e., irrelevant tuples—may be discarded. Downstream operators—i.e., operator 5—may receive the relevant tuples and perform other actions, such as process the tuples using an algorithm that performs a more compute-intensive algorithm, alert a system administrator, store the relevant tuples in a database, and the like. After executing for some period of time, the operator may have identified a plurality of both relevant and irrelevant data tuples.

The pattern detector 245 may constantly, or at intervals, evaluate the relevant tuples to determine whether there is a trait shared by the tuples or a recognizable pattern that establishes a relationship between the relevant tuples. For example, the pattern detector 245 may determine that 90% of the relevant tuples identified by operator 2 are dump trucks traveling south on the highway between the hours of 10:00 AM-12:00 PM. For example, the dump trucks may be taking a load of material to a work site in the morning, but when they return in the afternoon, the trucks have dumped their load and no longer damage the road above the set threshold.

In one embodiment, a stream programmer configures the pattern detector 245 with one or more predefined statistic thresholds that determine when the relevant tuples form a pattern or have a common trait. The pattern detector 245 may use any statistical or probability distribution or pattern recognizer to identify the common traits or pattern. For example, the pattern detector 245 may evaluate the relevant data to see if they have common attributes that have, to a certain degree, the same value—e.g., Vehicle Type=Dump Truck. That is, the pattern detector 245 determines whether the common trait applies to substantially all of the relevant tuples. As used here, “substantially all” represents that not all the relevant tuples must have a shared trait for the pattern detector 245 to identify a pattern. For example, the stream programmer may configure the pattern detector 245 to ensure that at least 85% of the relevant tuples have the same value for the trait. Thus, the pattern detector 245 may be configured to permit some degree of error or uncertainty that a pattern may not apply to all of the relevant tuples.

Moreover, the pattern detector 245 may evaluate metadata associated with the tuple apart from the data stored in the attribute value pairs—e.g., a timestamp of the tuple. For example, the pattern detector 245 may recognize that relevant tuples occur most frequently at certain time periods in the day or that relevant tuples are identified in groups of consecutively received tuples. One of ordinary skill in the art will recognize the different techniques for identifying patterns and common traits from the relevant tuples.

In one embodiment, the pattern detector 245 may use the identified pattern as filtering criteria for the algorithm used in operator 2. For example, operator 2 may filter each received tuple to see if metadata or the attribute value pairs satisfy the criteria—e.g., a received tuple defines a dump truck traveling south on the highway between the hours of 10:00 AM-12:00 PM. If not, operator 2 may not process the tuple using the algorithm. Thus, the filtering criteria may be used to determine between relevant and irrelevant data tuples without processing the tuples using the pre-configured code elements in the operator. In another embodiment, the filtering criteria may be used such that only the tuples that satisfy the filtering criteria are processed by the operator. Before the pattern detector 245 generated the filtering criteria based on a recognized common trait, operator 2 may process each tuple using the algorithm. However, after generating the filtering criteria, operator 2 may process only the received tuples that satisfy the criteria. In this manner, the filtering criteria may be used to increase tuple throughput or efficiently use hardware resources and processing time.

The pattern detector 245 associated with operator 2 may also transmit the filtering criteria to be used by other operators. As shown by the ghosted lines, pattern detector 245 sends the filtering criteria 305 to operator 4 which may use filtering criteria 305 as discussed above—e.g., to identify relevant tuples or to process only the tuples that satisfy the criteria 305. Operator 4 may process the data in the same manner as operator 2 (i.e., have code elements that define the same algorithm) or may be configured to process tuples differently (i.e., perform different algorithms). For example, operators 2 and 4 may perform the same algorithm but are hosted on separate PEs and compute nodes to increase parallel processing. As such, operator 4 may process different tuples than operator 2. In another embodiment, operator 4 may use a different algorithm to process the same tuples as those processed by operator 2. In both scenarios, operator 4 may benefit from filtering received tuples based on the criteria 305 generated by the pattern detector 245. For example, assume that operator 4 also attempts to identify vehicles that are damaging the highway but it receives tuples originating from vehicles traveling on a different portion of the highway. Both operators 2 and 4 may have respective pattern detectors, but here pattern detector 245 on operator 2 first recognizes a pattern, e.g., the dump trucks may pass through that portion of the highway associated with operator 2 before passing the highway portion monitored by operator 4. Thus, when the dump trucks are on the portion of highway associated with operator 4, the operator may use the filtering criteria 305 to immediately identify the tuples corresponding to the dump trucks as relevant and, for example, forward them to operator 5. This may enable operator 4 to process other received tuples quicker. Alternatively, operator 4 may perform a more in depth analysis of the tuples that satisfy the filtering criteria than it would if the tuples did not satisfy the filtering criteria.

Generally, any pattern detector may transmit filtering criteria to any other operator in the streaming application. Furthermore, a pattern detector in one streaming application may generate filtering criteria that is used in a different streaming application. In addition, the pattern detector 245 may transmit the filtering criteria 305 to more than one operator. For example, the streaming application may have five operators that each perform different algorithms on the same data tuples. If any one of the operators identify a common trait among the tuples that are identified as relevant, the operator may use its respective pattern generator to establish filtering criteria which is then transmitted to the other four operators. Further still, a single operator may have filtering criteria that is a combination of filtering criteria sent from more than one operator. That is, an operator may filter incoming tuples based on patterns identified by a plurality of operators.

Although the pattern detector is shown as being located on the operators, in one embodiment, the pattern detector may be centralized on a processing element or on the stream manager such that the pattern detector is responsible for identifying patterns or common traits for a plurality of operators. A centralized pattern detector may be able to identify patterns across multiple operators by looking at the relevant tuples of all the plurality of operators as a whole rather than evaluating only the relevant tuples identified by each operator.

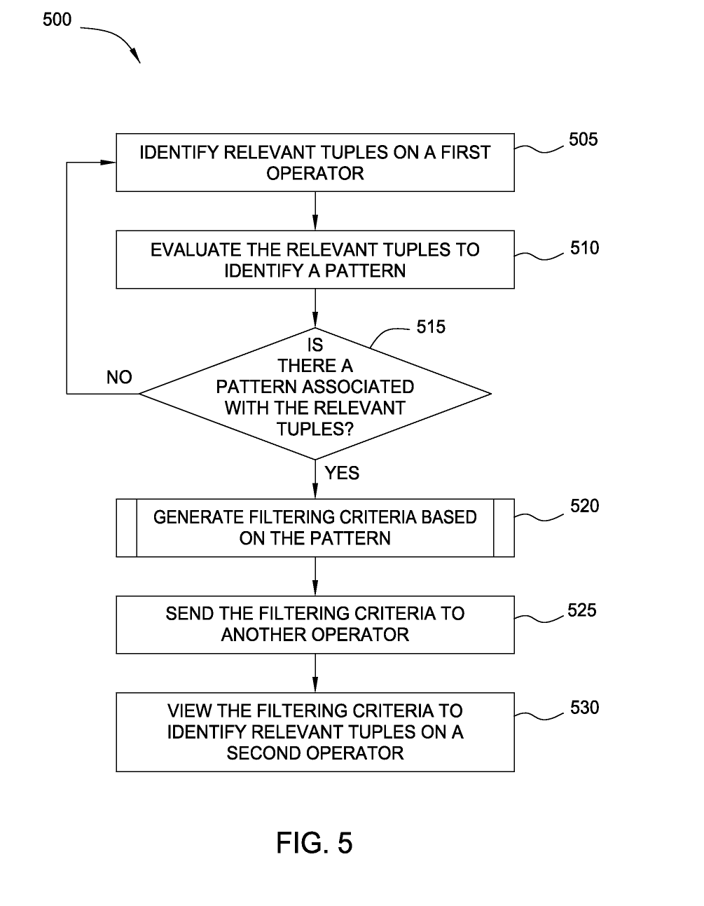

FIG. 5 illustrates a method 500 for generating filtering criteria based on recognized traits or patterns, according to one embodiment described herein. At block 505, an operator receives data tuples, processes the tuples, and classifies the tuples as either relevant or irrelevant. As used herein, relevant tuples are those that are used by a pattern detector to identify patterns or common traits. That is, the operator performs at least some amount of processing to characterize the tuples. For example, the operator may characterize the tuples based on whether the tuples satisfy one or more thresholds associated with an operator's algorithm. In other embodiments, the operator may characterize the tuples further than only characterizing the tuples as relevant or irrelevant (e.g., assign a degree of relevance to received tuples). After classifying the received tuples, the operator may perform any action on a relevant tuple such as forwarding the tuple to the next operator, modifying the tuple, sending the tuple to a database for storage, or even discarding or ignoring the tuple.

At block 510, the pattern detector evaluates the relevant tuples to determine whether there is a common trait or pattern. That is, in one embodiment, the pattern detector may evaluate only the tuples that the operator has previously deemed interesting or relevant. For example, the pattern detector may recognize that most or all of the relevant tuples have the same value for a particular attribute, e.g., 95% of the relevant tuples have a name attribute set to Fredrick. In another example, based on the metadata associated with the tuples, the pattern detector may recognize that substantially all of the relevant tuples occur during the same period every day or that relevant tuples are usually received as a group of a five consecutive tuples. The present disclosure, however, is not limited to any particular method or technique for identifying a pattern. That is, the pattern detector may use any pattern identifying technique for determining a pattern based on a common trait shared among the relevant tuples or metadata about the tuples.

In one embodiment, the pattern detector may use a priority or a degree of relevance when determining whether a pattern exists. For example, an operator may characterize tuples as having low, medium, or high relevance. Medium and high relevance tuples may be evaluated by the pattern detector while low relevance tuples are not. If 95% of the high relevance tuples include name attributes of Fredrick while only 50% of the medium relevance tuples have name attributes of Fredrick, the pattern detector may still identify Fredrick as a common trait. That is, the pattern detector may consider the degree of relevance of the tuples when determining patterns. Thus, the pattern detector may be configured such that if 95% of the high relevance tuples, but only 30% of the medium relevance tuples, have the same attribute, the pattern detector does not determine that the attribute value is a common trait.

At block 515, if the pattern detector does not identify a pattern, the method 500 returns to step 505 so the pattern detector can evaluate newly identified relevant tuples and determine if a pattern arises. In this manner, the pattern detector may continue to evaluate more and more relevant tuples until a pattern is detected. However, the pattern detector may be configured to ignore relevant tuples that have become stale—i.e., tuples that were processed by the operator before a predefined time threshold.

If the pattern detector does identify a patter, at block 520, the pattern detector generates filtering criteria based on the common trait or the metadata. The filtering criteria may include the common traits, such as specific values of attributes, or a value or range of metadata. For example, the criteria may be whether the name attribute of a received tuple has a value of “Fredrick” or whether the time stamp of the tuple is between 10:00 AM and 12:00 PM. In this manner, the filtering criteria may be used to screen received tuples. The operator may be configured to only process tuples that satisfy the filtering criteria or use the filtering criteria to determine what tuple should be forwarded to a downstream operator.

At block 525, the filtering criteria is sent to another operator. When configuring the streaming application, a stream administrator may configure pattern detectors or operators with a list of other related operators. If the pattern detector generates filtering criteria based on an identified pattern, the detector transmits the filtering criteria to the list of related operators. As shown in FIG. 4, operator 2 is preconfigured such that the pattern detector 245 transmits the generated filtering criteria to operator 4.

At block 530, the operator or operators that received the filtering criteria use the criteria to screen or filter received tuples. Although a plurality of operators may receive the criteria for the originating operator, the plurality of operators may use the criteria differently. For example, one operator may use the filtering criteria to determine whether to forward or to disregard received tuples while another tuple may use the criteria to determine whether to process the tuples using its typical code elements or forward the tuple without further processing. Thus, the filtering criteria may be loaded onto one or more remote operators and used to determine how to process and manage incoming data tuples in any manner desired.

In one embodiment, the filtering criteria may be used to reorder how received tuples are processed. In many streaming applications, an operator may receive a group of tuples during a single transmission. The operator may use the filtering criteria to pre-process the group of tuples and re-arrange the tuples based on the results. For example, the operator may process first the tuples that satisfied the filtering criteria, even if these tuples were received after other tuples in the group.

Although not shown in FIG. 5, method 500 may reset or invalidate the filtering criteria. Once the filtering criteria is invalidated, the operator no longer uses the filtering criteria to process received tuples. A filtering criteria may be invalidated using a plurality of different factors such as windowing conditions, triggers, or timers. That is, the filtering criteria may have a corresponding time limit that, when it expires, invalidates the criteria such that the operator no longer uses the filtering criteria to process received tuples. Alternatively, the filtering criteria may be deemed stale after processing a certain number (i.e., a window) of tuples using the criteria. Further still, an operator may cease using the filtering criteria upon determining a certain event has occurred. The operator may, for example, receive a trigger that indicates that the event has occurred. An example trigger may be that a new file is loaded into the streaming application which will generate data tuples substantially different from the tuples being processed previously. By resetting or invalidating the current filtering criteria, the streaming application identifies new patterns rather than using the patterns identified in the tuples associated with the previous file.

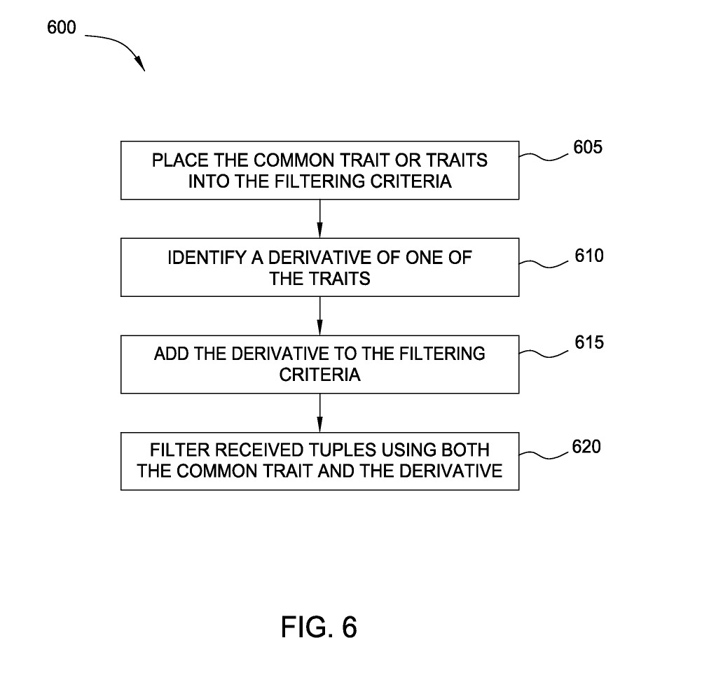

FIG. 6 illustrates a method 600 of using derivations of recognized traits or patterns in filtering criteria, according to one embodiment described herein. Specifically, method 600 is a more detailed explanation of one embodiment of performing step 520 of FIG. 5. So long as the pattern detector identifies at least one pattern of a common trait, at block 605, the pattern detector uses the pattern to generate the filtering criteria.

At block 610, the pattern detector identifies at least one derivative of the common traits. If the common trait is that the name attribute has a value of “Fredrick”, the pattern detector may add to the filtering criteria alternatives to Fredrick such as “Fred” or “Freddy”. Tuples with name attributes set to these derivatives would also satisfy the filtering criteria. Instead of using common derivations of names, other types of derivations are contemplated. For example, if the common trait is that the vehicle type attribute is a dump truck, a pattern detector may add vehicles that are similar in weight as dump truck—e.g., a concrete mixer truck or a semi-truck. The pattern detector may include a natural language processor or a look-up table for generating derivates of the common traits based on alternative spellings, synonyms, slang, preconfigured associations, abbreviations, and the like. In one embodiment, the derivations may be added to the filtering criteria by the pattern detector that identified the common trait, the pattern detector on the operator that receives the filtering criteria, or by some other module in the streaming application.

At block 620, an operator uses both the common trait and the derivative to filter received tuples. In one embodiment, if either the common trait or the derivative is found in a received tuple, the operator may perform the same action (e.g., processing the tuple, forwarding the tuple, ignoring the tuples, etc.). However, in another embodiment, the operator may perform a different function based on whether the common trait or the derivative is found in the tuple. For example, if the common trait is found in a received tuple, the operator may process the tuple using the code elements within the operator, modify an attribute based on the result, and forward the modified tuple to a downstream operator. If the derivative is found in the tuple, however, the operator only forwards the unmodified tuple to the downstream operator. In another example, the operator may process a group of received tuples (e.g., change the order in which the tuples are processed) based on which filtering criteria the received tuples satisfy. Tuples that satisfy the identified common trait may be processed first while tuples that satisfy a derivative of the common trait are processed second.

### CONCLUSION

When processing data tuples, the operators may identify certain tuples as being relevant. To determine relevant tuples, the operators may, for example, process the received tuples and determine if they meet certain thresholds. If so, the tuples are deemed relevant, but if not they are characterized as irrelevant. The streaming application may use a pattern detector to parse the relevant data tuples to identify a pattern such as a shared trait between the tuples. For example, substantially all of the relevant tuples may have the same value for an attribute in each of the tuples. Based on this commonality, the pattern detector may generate filtering criteria that may be used to process subsequently received tuples.

In one embodiment, the filtering criteria generated by evaluating the relevant tuples on one operator is transmitted to a second operator to be used to process tuples received there. For example, the two operators may perform the same algorithm when processing data but receive different data flows. Thus, once one of the operators determines a pattern, the operator generates filtering criteria that another, related operator uses for filtering received tuples. In one embodiment, if the tuples received by the second operator satisfy the filtering criteria, the second operator may continue to process the tuple using code elements in the second operator. If not, the second operator may not process the tuples further.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A system, comprising:
a computer processor; and
a memory containing a program that, when executed on the computer processor, performs an operation for processing data, comprising:
receiving streaming data tuples to be processed by a plurality of interconnected operators, the operators processing at least a portion of the received data tuples by operation of the computer processor;
processing tuples received by a first operator of the plurality of operators to identify relevant tuples that satisfy one or more criteria;
evaluating the relevant tuples to determine a pattern based on a commonality shared by at least a portion of the relevant tuples;
transmitting the shared commonality to a second operator of the plurality of operators; and
determining whether data tuples received by the second operator contain the shared commonality.

2. The system of claim 1, further comprising:
upon determining that one of the data tuples received by the second operator contain the shared commonality, performing a first action with the one data tuple; and
upon determining that the one data tuple received by the second operator does not contain the shared commonality, performing a second, different action with the one data tuple.

3. The system of claim 2, wherein the first action is processing the one data tuple based on one or more preconfigured code elements in the second operator and the second action is discarding the one data tuple such that the one data tuple is not forwarded to an operator downstream from the second operator.

4. The system of claim 2, wherein the first action is re-ordering the data tuples received by the second operator such that the one data tuple is processed before a second data tuple that was received by the second operator before the second operator received the one data tuple, wherein the second data tuple does not contain the commonality.

5. The system of claim 1, further comprising:
generating at least one derivative of the commonality, the derivative representing a suitable alternative of the commonality;
transmitting the derivative to the second operator; and
determining whether data tuples received by the second operator contain the shared commonality.

6. The system of claim 1, further comprising, upon determining that at least one criterion is satisfied, invalidating the identified commonality whereby the second operator ceases to determine whether the received data tuples contain the commonality.

7. A computer program product for processing data, the computer program product comprising:
a computer-readable storage medium having computer-readable program code embodied therewith, the computer-readable program code comprising computer-readable program code configured to:
receive streaming data tuples to be processed by a plurality of interconnected operators, the operators processing at least a portion of the received data tuples;
process tuples received by the first operator of the plurality of operators to identify relevant tuples that satisfy one or more criteria;
evaluate the relevant tuples to determine a pattern based on a commonality shared by at least a portion of the relevant tuples;
transmit the shared commonality to a second operator of the plurality of operators; and
determine whether data tuples received by the second operator contain the commonality.

8. The computer program product of claim 1, further comprising computer-readable program code configured to:
upon determining that one of the data tuples received by the second operator contain the shared commonality, perform a first action with the one data tuple; and
upon determining that the one data tuple received by the second operator does not contain the shared commonality, perform a second, different action with the one data tuple.

9. The computer program product of claim 8, wherein the first action is processing the one data tuple based on one or more preconfigured code elements in the second operator and the second action is discarding the one data tuple such that the one data tuple is not forwarded to an operator downstream from the second operator.

10. The computer program product of claim 8, wherein the first action is re-ordering the data tuples received by the second operator such that the one data tuple is processed before a second data tuple that was received by the second operator before the second operator received the one data tuple, wherein the second data tuple does not contain the commonality.

11. The computer program product of claim 7, further comprising computer-readable program code configured to:
generate at least one derivative of the commonality, the derivative representing a suitable alternative of the commonality;
transmit the derivative to the second operator; and
determine whether data tuples received by the second operator contain the derivative of the commonality.
